(19) United States
(12) Patent Application Publication
(10) Pub. No.: US 2009/0089397 A1
(43) Pub. Date: Apr. 2, 2009

(54) MULTICAST CONTROL APPARATUS, MULTICAST CONTROL SYSTEM, AND MULTICAST CONTROL METHOD

(75) Inventors: Motohiro MORI, Osaka (JP); Yuuji Nanba, Osaka (JP); Shuuichi Enomoto, Osaka (JP); Tooru Natsumi, Osaka (JP); Shigehiro Takeuchi, Osaka (JP); Hiroyuki Tanaka, Osaka (JP); Tomohiro Ikeda, Osaka (JP); Takashi Nagata, Osaka (JP)

Correspondence Address: Fujitsu Patent Center;C/O CPA Global, P.O. Box 52050, Minneapolis, MN, 55402, US

(73) Assignee: FUJITSU LIMITED, Kanagawa (JP)

(21) Appl. No.: 12/239,090

(22) Filed: Sep. 26, 2008

(30) Foreign Application Priority Data
Sep. 28, 2007 (JP) 2007-256104

(51) Int. Cl. G06F 15/16

(52) U.S. Cl. 709/217

(57) ABSTRACT

A multicast control apparatus includes: a delivery instructing unit, responsive to a first one of received viewing requests, to instruct delivery to a first external apparatus of the content data; a delivery determining unit to determine whether a corresponding number of deliveries of the content data exceeds a delivery limit; calculating units to calculate (1) a time necessary to create a cache of a copy of the content data and (2) a remaining time before viewing of the content data delivered from the first external apparatus is finished; a control unit to set a second and subsequent ones of the received viewing requests to a wait state if the delivery limit is exceeded by the first received viewing request, and to instruct creation of the cache to a second external apparatus if the necessary time is shorter than the remaining time.

### CROSS-REFERENCE TO RELATED APPLICATION

This application claims the benefit of priority from Japanese Patent Application No. 2007-256104 filed on Sep. 28, 2007, the entire contents of which are incorporated herein by reference.

### BACKGROUND

1. Field

At least one embodiment of the invention relates to multicast control apparatuses, multicast control systems, and multicast control methods.

2. Description of the Related Art

A Wide spread use of broadband in recent years enables multicast in which content data is concurrently delivered from a content server to multiple communication terminal apparatuses that are specified over a network, such as the Internet. In the related multicast art, a delivery control server stores data to be delivered in a packet buffer and reads out the data from the packet buffer to reproduce the data of a number corresponding to the number of communication terminal apparatuses to which the data is delivered and to deliver the reproduced data. In a typical Transmission Control Protocol/Internet Protocol (TCP/IP) network, when data is delivered to multiple communication terminal apparatuses specified by a delivery control server, the data is automatically divided into multiple data items in accordance with the number of communication terminal apparatuses specified by a router on the communication route. Accordingly, it is possible to realize efficient delivery without blocking the traffic of the communication network. As a result, the related multicast art has become widely used in delivery of videos, such as Streaming Video on demand.

However, in the related multicast art, if viewing requests for content data are intensively submitted from many communication terminal apparatuses, overflow of the link bandwidth, the packet reproduction capability of the router, the management capability of the router, and so on occurs thereby disrupting the multicast. This undermines stable delivery of the content data.

In the above situations, delivery control systems for the related multicast art are proposed in which the number of deliveries is restricted to allow the stable delivery of high-quality content data. For example, in a delivery control system disclosed in Japanese Laid-Open Patent Publication No. 2005-229465, a delivery control server, which counts and stores the maximum number of deliveries and the number of deliveries, controls delivery of content data. When the delivery control server receives a viewing request from each of the communication terminal apparatuses, the delivery control server counts the number of deliveries. The delivery control server continues to deliver the content data if the counted number of deliveries does not exceed the maximum number of deliveries.

The delivery control system disclosed in Japanese Laid-Open Patent Publication No. 2005-229465 has a problem when a state continues in which the number of deliveries exceeds the maximum number of deliveries because viewing requests for popular content data are intensively submitted. The delivery control system controls the delivery so as to realize sequential viewing by starting the viewing with one communication terminal apparatus after the viewing with another communication terminal apparatus is finished. Accordingly, it is not possible to deliver the content data to the communication terminal apparatus that has submitted the viewing request later until the session established with the communication terminal apparatus that has submitted the viewing request first is ended. In addition, the delivery control system disclosed in Japanese Laid-Open Patent Publication No. 2005-229465 has a problem in that the wait time of another communication terminal apparatus that has submitted a new delivery request becomes unstable. Furthermore, the delivery control system disclosed in Japanese Laid-Open Patent Publication No. 2005-229465 has a problem in that a person who requests delivery of content data is forced to pay the unnecessary request cost because the operating ratio of the content the delivery of which has been requested by the requesting person is not increased.

### SUMMARY

An embodiment of the invention provides a multicast control apparatus that includes: a receiving unit to receive viewing requests for content data; a delivery instructing unit, responsive to a first one of the received viewing requests, to instruct delivery to a first external apparatus of the content data; a delivery determining unit to determine whether a corresponding number of deliveries of the content data exceeds a delivery limit; calculating units to calculate (1) a time necessary to create a cache of a copy of the content data and (2) a remaining time before viewing of the content data delivered from the first external apparatus is finished; a control unit to set a second and subsequent ones of the received viewing requests to a wait state if the delivery limit is exceeded by the first received viewing request, and to instruct creation of the cache to a second external apparatus if the necessary time is shorter than the remaining time.

It is to be understood that both the foregoing general description and the following detailed description are exemplary and explanatory only and are not restrictive of the invention, as claimed.

### BRIEF DESCRIPTION OF THE DRAWINGS

FIG. 1 is a block diagram schematically showing an example of the entire configuration of a multicast control system according to an example embodiment of the invention;

FIG. 2 is a block diagram showing an example of the configuration of a streaming server apparatus according to an example embodiment of the invention;

FIG. 3 is a block diagram showing an example of the configuration of a delivery control server apparatus according to an example embodiment of the invention;

FIG. 4 shows an example of a content management information table according to an example embodiment of the invention;

FIG. 5 shows an example of a delivery management information table according to an example embodiment of the invention;

FIG. 6 shows an example of a reserved viewer list according to an example embodiment of the invention;

FIG. 7 is a flowchart, according to an example embodiment of the invention, showing a multicast control process performed when a viewing request is submitted;

FIG. 8 is a flowchart, according to an example embodiment of the invention, showing the multicast control process performed when a viewing request is submitted;

FIG. 9 is a flowchart, according to an example embodiment of the invention, showing a multicast control process performed when creation of a cache is finished;

FIG. 10 is a flowchart, according to an example embodiment of the invention, showing a multicast control process performed when viewing is finished; and

FIG. 11 is a flowchart, according to an example embodiment of the invention, showing the multicast control process performed when viewing is finished.

### DESCRIPTION OF THE EXAMPLE EMBODIMENTS

Japanese Patent Application No. 2007-256104, filed on Sep. 28, 2007, is herein incorporated by reference in its entirety.

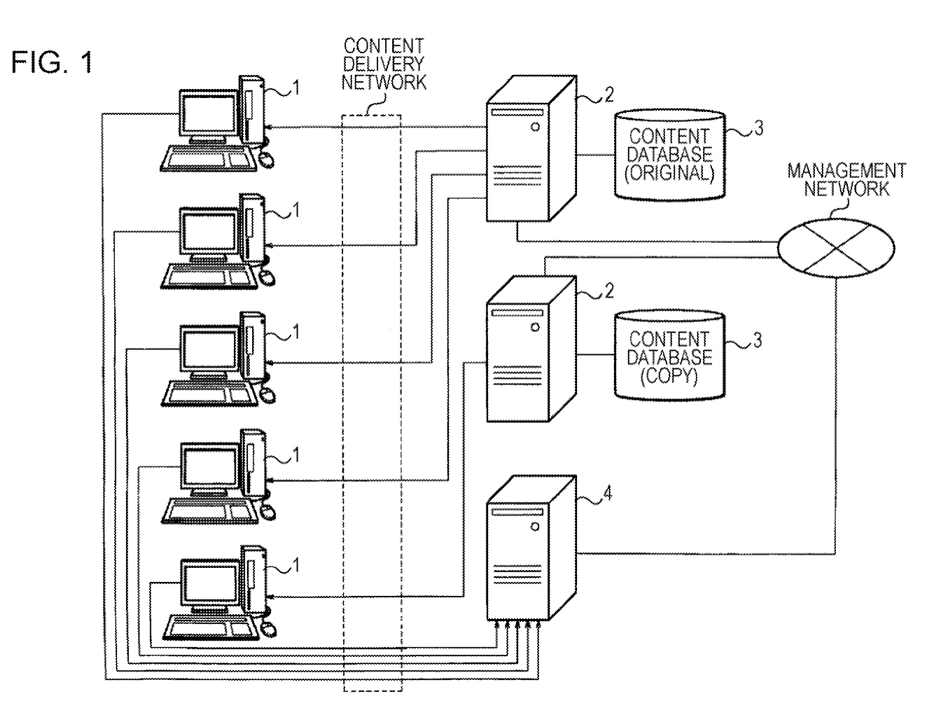

A multicast control apparatus, a multicast control system, and a multicast control method according to embodiments of the invention will herein be described with reference to the attached drawings. FIG. 1 is a block diagram schematically showing an example of the entire configuration of a multicast control system according to an example embodiment of the invention.

Referring to FIG. 1, the multicast control system according to the embodiment includes multiple communication terminal apparatuses 1, 1, . . . , multiple streaming server apparatuses 2, 2, . . . , content databases 3, 3, . . . connected to the streaming server apparatuses 2, and a delivery control server apparatus 4. The communication terminal apparatuses 1 are connected to the streaming server apparatus 2 over a content delivery network. The communication terminal apparatuses 1 are connected to the delivery control server apparatus 4 over the content delivery network. Each of the streaming server apparatuses 2 is connected to the delivery control server apparatus 4 over a management network.

At reception of a viewing request for content data input by a viewer who wants to view the content data, the communication terminal apparatus 1 transmits the received viewing request for the content data to the delivery control server apparatus 4.

The delivery control server apparatus 4 receives the viewing request from the communication terminal apparatus 1 and performs a multicast control process described below. If the delivery control server apparatus 4 determines that the current number of deliveries is smaller than the maximum number of deliveries in the multicast control system in the process, the delivery control server apparatus 4 transmits an instruction to deliver the content data to the streaming server apparatus 2.

The streaming server apparatus 2 receives the instruction to deliver the content data from the delivery control server apparatus 4 and establishes a session with the communication terminal apparatus 1 which has submitted the viewing request by using a communication protocol, e.g., such as Real-time Transport Protocol (RTP), RTP Control Protocol (RTCP), or Real Time Streaming Protocol (RTSP) to deliver the content data to the communication terminal apparatus 1 by streaming.

If the delivery control server apparatus 4 determines that the current number of deliveries is not smaller than the maximum number of deliveries in the multicast control system, the delivery control server apparatus 4 calculates a time t1 necessary to create a cache. Then, the delivery control server apparatus 4 calculates a remaining viewing time t2 of the first viewer who will finish the viewing among the viewers who are viewing content data. If the delivery control server apparatus 4 determines that the necessary time t1 is shorter than the remaining viewing time t2, the delivery control server apparatus 4 determines that the creation of a cache is necessary and transmits an instruction to create a cache to the streaming server apparatus 2 in which original content data is held.

The streaming server apparatus 2 receives the instruction to create a cache from the delivery control server apparatus 4 and transmits a copy of the content data to a preliminary streaming server apparatus 2. The streaming server apparatus 2 transmits a notification that the creation of a cache is started to the delivery control server apparatus 4.

The preliminary streaming server apparatus 2 receives the copy of the content data from the streaming server apparatus 2. The preliminary streaming server apparatus 2 stores the received copy of the content data in a free space in the content database 3 to which the preliminary streaming server apparatus 2 is connected and creates a cache.

The delivery control server apparatus 4 receives the notification that the creation of a cache is started from the streaming server apparatus 2 and newly registers the ID of the cached content, the number of the preliminary streaming server apparatus 2 which has created the cache, and the cache creation start time when the creation of the cache is started in a reserved viewer list T3 described below.

The streaming server apparatus 2 transmits a notification that the creation of the cache is finished to the delivery control server apparatus 4.

The delivery control server apparatus 4 receives the notification that the creation of the cache transmitted from the streaming server apparatus 2 is finished. Then, the delivery control server apparatus 4 transmits to the preliminary streaming server apparatus 2 a content data delivery instruction to deliver the content data to the communication terminal apparatus 1 indicated by the ID of the viewer which is registered in the reserved viewer list T3 described below and which is in a wait state.

The preliminary streaming server apparatus 2 receives the delivery instruction transmitted from the delivery control server apparatus 4 and establishes a session with the communication terminal apparatus 1 which has submitted the viewing request to deliver the content data to the communication terminal apparatus 1 by the streaming.

When the communication terminal apparatus 1 receives a pause request inputted by the viewer, the communication terminal apparatus 1 transmits the received pause request to the streaming server apparatus 2 that is delivering the content data.

The streaming server apparatus 2 receives the pause request transmitted from the communication terminal apparatus 1 and transmits the received pause request and the ID of the viewer who has submitted the pause request to the delivery control server apparatus 4.

The delivery control server apparatus 4 receives the pause request and the ID of the viewer transmitted from the streaming server apparatus 2 and updates the accumulated pause time and the count of pauses corresponding to the received ID of the viewer in a delivery management information table T2 described below.

The streaming server apparatus 2 transmits a delivery state of the content data to the delivery control server apparatus 4.

The delivery control server apparatus 4 receives the delivery state from the streaming server apparatus 2 and updates a viewing state in the delivery management information table T2 described below in accordance with the received delivery state.

The delivery control server apparatus 4 measures the current accumulated pause time and transmits a prohibition instruction for prohibiting the pause to the streaming server apparatus 2 if the delivery control server apparatus 4 determines that the current accumulated pause time exceeds a reference accumulated pause time.

Alternatively, the delivery control server apparatus 4 may count the current count of pauses and may transmit the prohibition instruction for prohibiting the pause to the streaming server apparatus 2 if the delivery control server apparatus 4 determines that the current count of pauses exceeds a reference count of pauses.

The streaming server apparatus 2 receives the prohibition instruction transmitted from the delivery control server apparatus 4 and does not stop the delivery of the content data in accordance with the received prohibition instruction.

The communication terminal apparatus 1 finished the playback of the content data transmits a notification that the viewing of the content data is finished to the streaming server apparatus 2 delivering the content data.

The streaming server apparatus 2 delivering the content data receives the notification that the viewing of the content data is finished, which is transmitted from the communication terminal apparatus 1 and stops the delivery of the content data. The streaming server apparatus 2 transmits the notification that the viewing of the content data is finished to the delivery control server apparatus 4.

The delivery control server apparatus 4 receives the notification that the viewing of the content data is finished, which is transmitted from the streaming server apparatus 2 and transmits an instruction for deleting the cache to the preliminary streaming server apparatus 2 created the cache.

The preliminary streaming server apparatus 2 receives the instruction for deleting the cache transmitted from the delivery control server apparatus 4 and deletes the cache in the content database 3 to which the preliminary streaming server apparatus 2 connected.

The streaming delivery mentioned above will now be described. Since the streaming server apparatus 2 realizes real-time transmission according to the RTP, the streaming server apparatus 2 transmits communication control data, e.g., such as synchronous clock information, an order number, and a data type, to the communication terminal apparatus 1 with the content data.

The communication terminal apparatus 1 plays back the content data in real time on the basis of the communication control data. The communication terminal apparatus 1 transmits communication control data, e.g., such as an effective bandwidth and a delay time, to the streaming server apparatus 2 according to the RTCR

The streaming server apparatus 2 receives the communication control data from the communication terminal apparatus 1 and delivers the content data to the communication terminal apparatus 1 while adjusting the quality of the content data to be delivered according to the RTP based on the received communication control data.

The configuration and operation of each of the communication terminal apparatus 1 will now be described. The communication terminal apparatus 1 is, for example, a personal computer, a mobile phone, or a mobile motion video player that can be connected to the content delivery network. The communication terminal apparatus 1 at least includes a communication unit that receives content data delivered by streaming, a control unit, and an output unit. The control unit and the output unit play back the received content data in real time. The communication terminal apparatus 1 grants an operation right to each viewer. The viewer ID for identifying each viewer is used for identifying the communication terminal apparatus 1 in the multicast control system according to the embodiment. The communication terminal apparatus 1 is operated by the viewer and performs processes described below in order to play back the content data delivered by streaming in real time.

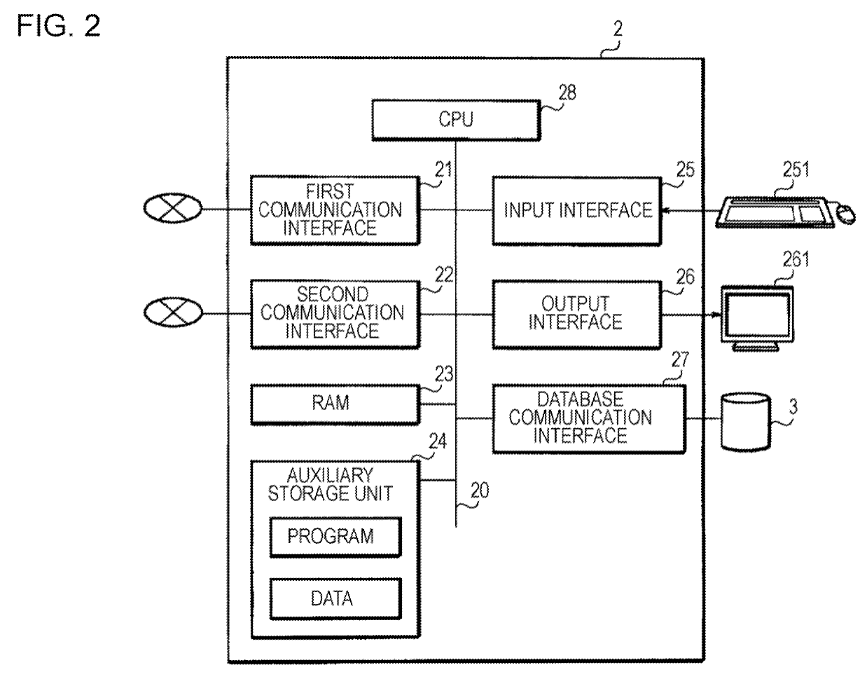

The configuration and operation of each streaming server apparatus 2 will now be described. FIG. 2 is a block diagram, according to an example embodiment of the invention, showing an example of the configuration of the streaming server apparatus 2. The streaming server apparatus 2 includes a first communication interface 21, a second communication interface 22, a random access memory (RAM) 23, an auxiliary storage unit 24, an input interface 25, an output interface 26, a database communication interface 27, and a central processing unit (CPU) 28. The hardware components are connected to each other via a bus 20.

The multicast control system according to the embodiment includes multiple preliminary streaming server apparatuses 2 that cache copies of content data, in addition to the streaming server apparatus 2 managing the original content data.

The first communication interface 21 is an end of the content delivery network and functions as a connection unit for communication with the communication terminal apparatus 1 via the content delivery network. The content delivery network should be understood as including a communication network over which digital content data, e.g., such as motion video data, is delivered by streaming. The content delivery network is, for example, the Internet, an intranet, an extranet, a local area network (LAN), an integrated services digital network (ISDN), a value added network (VAN), a community antenna television (CATV) communication network, a virtual private network, a telephone network, a mobile communication network, or a satellite communication network. The first communication interface 21 transmits, for example, content data or communication control data to the communication terminal apparatus 1. The first communication interface 21 receives communication control data from the communication terminal apparatus 1 and supplies the received communication control data to the RAM 23.

The second communication interface 22 is an end of the management network and functions as a connection unit for communication with other streaming server apparatuses 2 and the delivery control server apparatus 4 via the management network. The management network should be understood as including a communication network over which a copy of content data is transmitted from the streaming server apparatus 2 to another streaming server apparatus 2 where the copy of the content data is cached. The management network is, for example, the Internet, an intranet, an extranet, a LAN, an ISDN, a VAN, a CATV communication network, a virtual private network, a telephone network, a mobile communication network, or a satellite communication network. The second communication interface 22 transmits, for example, a copy of content data to be cached to another streaming server apparatus 2 where the copy of the content data is cached. The second communication interface 22 receives, for example, a copy of content data transmitted from the streaming server apparatus 2, a cache creation instruction transmitted from the delivery control server apparatus 4, and a cache deletion instruction transmitted from the delivery control server apparatus 4.

The RAM 23 is a main memory capable of storing multiple pieces of information and reading out the information irrespective of storage order and storage location. The RAM 23 is classified into a static RAM or a dynamic RAM. The RAM 23 stores, for example, programs read out from the auxiliary storage unit 24, a variety of data generated by executing the programs, and a variety of information externally received. The RAM 23 appropriately reads out the variety of information that is stored in response to a read instruction from the CPU 28.

The auxiliary storage unit 24 is, for example, a hard disk, which is a magnetic storage device. The auxiliary storage unit 24 stores, for example, programs used for delivering content data by streaming and programs and a variety of data used for creating caches. The auxiliary storage unit 24 appropriately reads out the stored programs in response to a read instruction from the CPU 28.

The input interface 25 is connected to an input device 251. The input device 251 is, for example, a keyboard or a mouse. The input device 251 is operated by a server manager who inputs various instructions for maintenance and management of the streaming server apparatus 2. The input interface 25 receives the various instructions input with the input device 251 and supplies the received various instructions to the CPU 28.

The output interface 26 is connected to a display device 261. The display device 261 is used for displaying information for maintenance and management of the streaming server apparatus 2. The output interface 26 supplies the information for maintenance and management of the streaming server apparatus 2 to the display device 261.

The database communication interface 27 is connected to the content database 3 and functions as a connection unit for communication with the content database 3. The content database 3 stores original content data or a cache of a copy of the content data.

The CPU 28 controls each hardware component in the streaming server apparatus 2 to perform various processes including deliver of content data by streaming, reproduction of content data, and creation of caches. Example processes performed by the CPU 28 will be described in detail below.

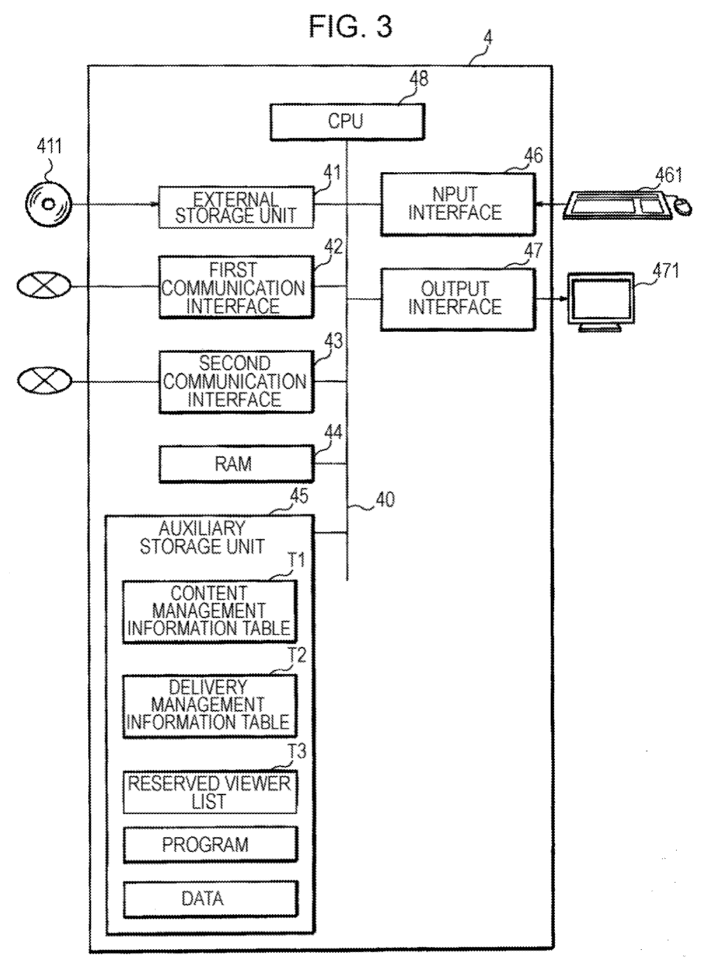

An example configuration and operation of the delivery control server apparatus 4 will now be described. FIG. 3 is a block diagram, according to an example embodiment of the invention, showing an example of the configuration of the delivery control server apparatus 4. The delivery control server apparatus 4 includes an external storage unit 41, a first communication interface 42, a second communication interface 43, a RAM 44, an auxiliary storage unit 45, an input interface 46, an output interface 47, and a CPU 48. The hardware components are connected to each other via a bus 40.

The external storage unit 41 reads out programs or a variety of data recorded in a recording medium 411. When the recording medium 411 is loaded in an insertion slot (not shown), the external storage unit 41 reads out the programs or the variety of data recorded in the loaded recording medium 411 and supplies the readout programs or variety of data to the auxiliary storage unit 45.

The first communication interface 42 is an end of the content delivery network and functions as a connection unit for communication with the communication terminal apparatuses 1 over the content delivery network. The first communication interface 42 transmits, for example, communication control data to each communication terminal apparatus 1. The first communication interface 42 receives, for example, communication control data, a viewing request for content data, and a notification that the viewing of content data is finished from the communication terminal apparatus 1 and supplies them to the RAM 44.

The second communication interface 43 is an end of the management network and functions as a connection unit for communication with the streaming server apparatuses 2 over the management network. The second communication interface 43 transmits, for example, an instruction to deliver content data, an instruction to create a cache, and an instruction to delete a cache to the streaming server apparatus 2. The second communication interface 43 receives, for example, a notification that the creation of a cache is finished from the streaming server apparatus 2 and supplies the notification to the RAM 44.

The RAM 44 is a main memory capable of storing multiple pieces of information and reading out the information irrespective of storage order and storage location. The RAM 44 is classified into a static RAM or a dynamic RAM. The RAM 44 stores, for example, programs read out from auxiliary storage unit 45, a variety of data generated by executing the programs, and a variety of information externally received. The RAM 44 appropriately reads out the variety of information that is stored in response to a read instruction from the CPU 48.

The auxiliary storage unit 45 is, for example, a hard disk, which is a magnetic storage device. The auxiliary storage unit 45 stores, for example, programs used for outputting an instruction to deliver content data, programs used for outputting an instruction to create a cache and an instruction to delete a cache, and a variety of data. The auxiliary storage unit 45 stores a content management information table T1, the delivery management information table T2, and the reserved viewer list T3. The auxiliary storage unit 24 appropriately reads out the stored programs in response to a read instruction from the CPU 48.

The input interface 46 is connected to an input device 461. The input device 461 is, for example, a keyboard or a mouse. The input device 461 is operated by the server manager who inputs various instructions for maintenance, management, and delivery control of the delivery control server apparatus 4. The input interface 46 receives the various instructions input with the input device 461 and supplies the received various instructions to the CPU 48.

The output interface 47 is connected to a display device 471. The display device 471 is used for displaying information for maintenance, management, and delivery control of the delivery control server apparatus 4. The output interface 47 supplies the information for maintenance, management, and delivery control of the delivery control server apparatus 4 to the display device 471.

The CPU 48 controls each hardware component in the delivery control server apparatus 4 to receive a viewing request of content data or a notification that viewing of content data is finished from each of the communication terminal apparatuses 1. The CPU 48 performs processes for transmitting, for example, the instruction to deliver content data, the instruction to create a cache, and the instruction to delete a cache to the streaming server apparatus 2. Example processes performed by the CPU 48 will be described in detail below.

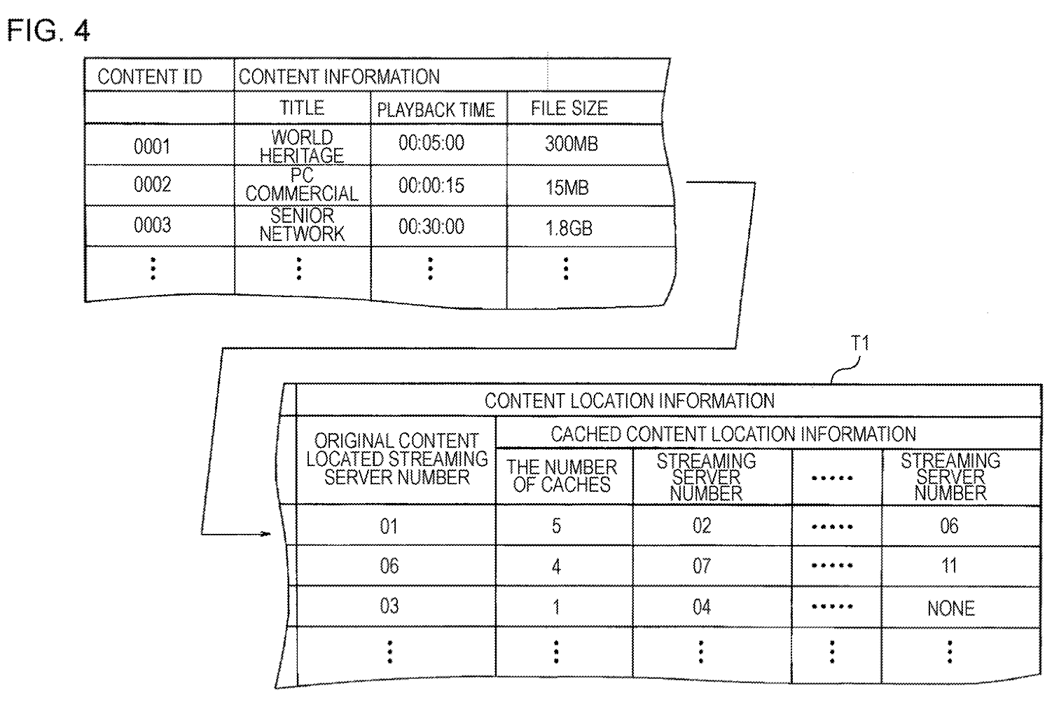

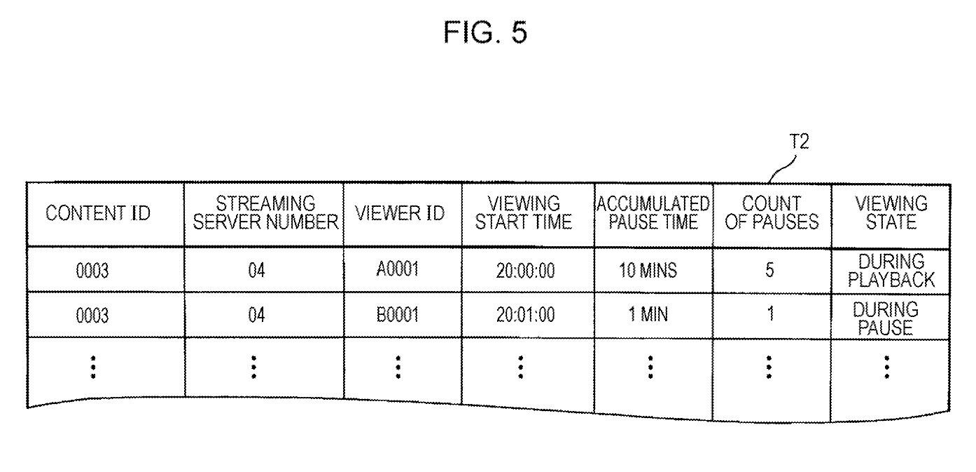

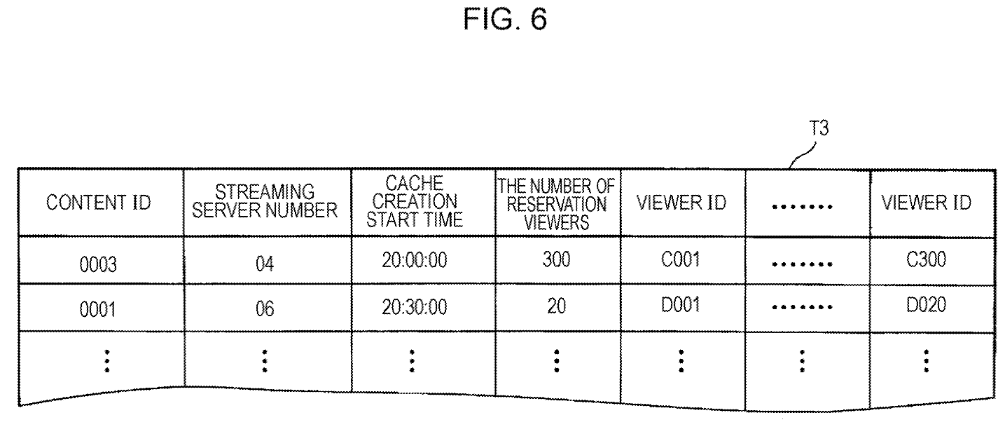

Examples of the content management information table T1, the delivery management information table T2, and the reserved viewer list T3, which are stored in the auxiliary storage unit 45 in the delivery control server apparatus 4, will now be described. FIG. 4 shows an example of the content management information table T1 according to an embodiment of the invention. FIG. 5 shows an example of the delivery management information table T2 according to an embodiment of the invention. FIG. 6 shows an example of the reserved viewer list T3 according to an embodiment of the invention.

The content management information table T1 includes content management information used for managing content data. The content management information for every content ID is stored in the content management information table T1. The content management information includes content information and content location information for every content ID. The content information includes the title of each content, the playback time of each content data, and the file size of each content data. The content location information includes the original content located streaming server number of each content and cached content location information about each content. The cached content location information includes the number of caches of each content and the number (numbers) of the streaming server apparatus (apparatuses) 2 where the cache (caches) of each content is created.

The content information and the original content located streaming server number are set in advance by a person who requests delivery of the content data and are newly registered or updated in the content management information table T1. The cached content location information is newly registered when the preliminary streaming server apparatus 2 creates a cache. The streaming server number is added and updated each time the preliminary streaming server apparatus 2 creates a cache.

The delivery management information table T2 includes delivery management information used for managing delivery of content data. The delivery management information for every content ID is stored in the delivery management information table T2. The delivery management information includes the number of the streaming server that delivers each content data, the ID of the viewer who views the delivered content data, the viewing start time when the viewing of the delivered content data is started, the accumulated pause time indicating the accumulated time of the pause time when the playback of each content data is stopped, the count of pauses, and the viewing state of each content data. The content ID, the streaming server number, the viewer ID, and the viewing start time are newly registered when the streaming server apparatus 2 starts deliver of each content data. The accumulated pause time and the count of pauses are updated each time the delivery control server apparatus 4 receives the pause request from the streaming server apparatus 2. The viewing state is updated each time the delivery control server apparatus 4 receives the delivery state of the content data from the streaming server apparatus 2. For example, the viewing state is updated during playback or during pause.

The reserved viewer list T3 includes the IDs of viewers who are in the wait state because the current number of deliveries exceeds the maximum number of deliveries in the multicast control system. The IDs of the viewers are stored in the reserved viewer list T3 for every content ID for which the viewing request has been submitted. The reserved viewer list T3 includes the ID of each content for which the viewing request has been submitted, the number of the preliminary streaming servers 2 that cache the content data, the cache creation start time when creation of the cache is started in the streaming server 2, the number of reservation viewers who wait for delivery of the content data, and the IDs of viewers who wait for delivery of the content data. The content ID, the streaming server number, and the cache creation start time are newly registered when the streaming server apparatus 2 starts the creation of a cache. The number of reservation viewers and the viewer IDs are updated when the viewing requests of the number exceeding the maximum number of deliveries are received.

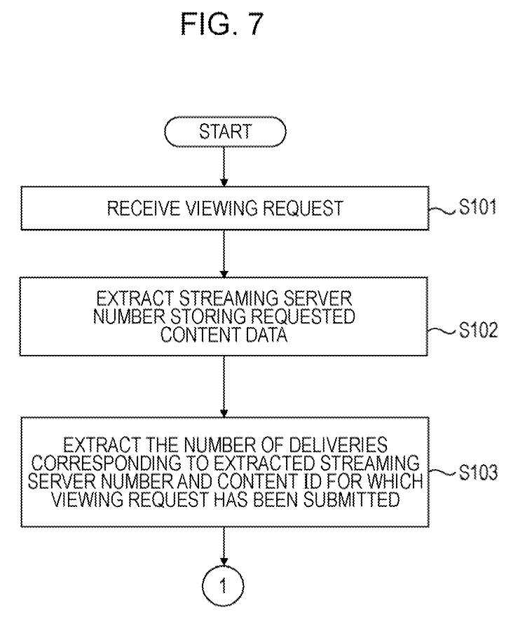

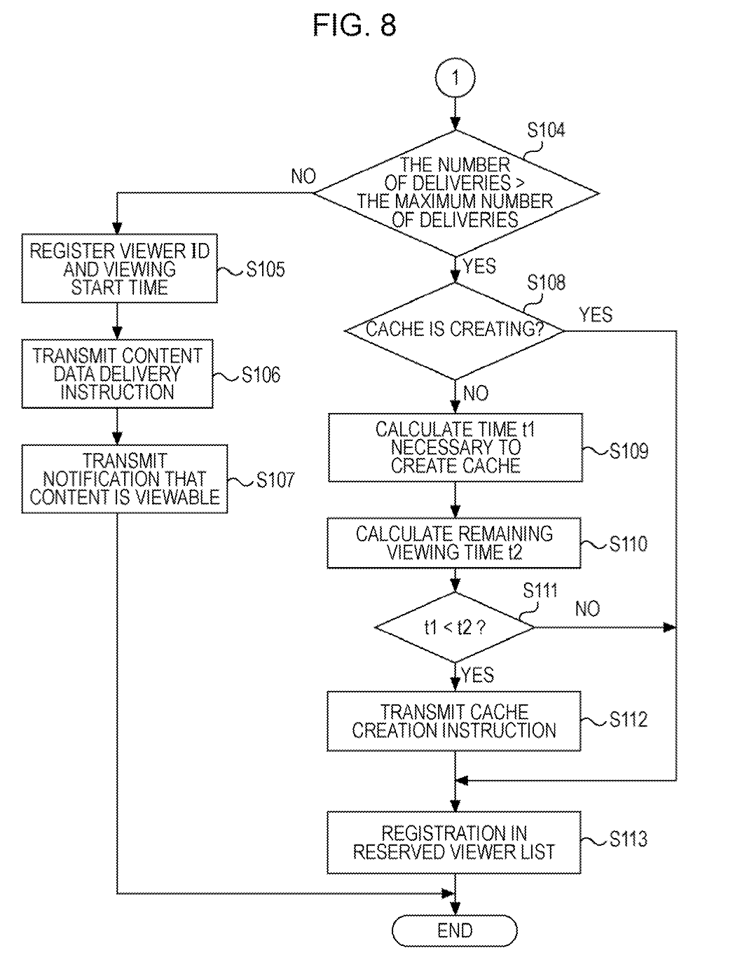

An example multicast control process performed by the delivery control server apparatus 4 when a viewing request is submitted will now be described. FIGS. 7 and 8 are flowcharts, according to respective example embodiments of the invention, showing an example of the multicast control process performed when a viewing request is submitted. A user who wants to view content data inputs a viewing request for the content data with the communication terminal apparatus 1 for which the user has the operation right. When the communication terminal apparatus 1 receives the viewing request for the content data, the communication terminal apparatus 1 transmits the received viewing request to the delivery control server apparatus 4.

Referring to FIG. 7, in Step S101, the CPU 48 in the delivery control server apparatus 4 receives the viewing request from the communication terminal apparatus 1. In Step S102, the CPU 48 extracts the number of the streaming server 2 in which the requested content data is stored from the content management information table T1. In Step S103, the CPU 48 extracts the number of deliveries corresponding to the extracted streaming server number and the ID of the content for which the viewing request has been submitted from the content management information table T1. Referring to FIG. 8, in Step S104, the CPU 48 determines whether the extracted number of deliveries is not smaller than the maximum number of deliveries that is set in advance.

If the CPU 48 determines that the extracted number of deliveries is smaller than the maximum number of deliveries (the determination in Step S104 is negative), then in Step S105, the CPU 48 registers the ID of the viewer who has submitted the viewing request and the viewing start time in the delivery management information table T2. In Step S106, the CPU 48 transmits an instruction to deliver the content data to the streaming server apparatus 2 indicated by the extracted streaming server number. The CPU 48 also transmits the ID of the viewer who has submitted the viewing request to the streaming server apparatus 2. In Step S107, the CPU 48 transmits a notification that the content is viewable to the communication terminal apparatus 1 corresponding to the ID of the viewer who has submitted the viewing request. Then, the multicast control process performed when a viewing request is submitted is terminated.

The CPU 28 in the streaming server apparatus 2 receives the instruction to deliver the content data and the viewer ID from the delivery control server apparatus 4 and delivers the specified content data to the communication terminal apparatus 1 corresponding to the viewer ID.

If the CPU 48 determines in Step S104 that the extracted number of deliveries is not smaller than the maximum number of deliveries (the determination in Step S104 is affirmative), then in Step S108, the CPU 48 determines whether a cache of the content data for which the viewing request has been submitted is being created in the preliminary streaming server apparatus 2. If the CPU 48 determines that a cache of the content data for which the viewing request has been submitted is being created in the preliminary streaming server apparatus 2 (the determination in Step S108 is affirmative), then in Step S113, the CPU 48 registers the ID of the viewer who has submitted the viewing request in the reserved viewer list T3 in association with the ID of the cached content and the number of the preliminary streaming server apparatus 2 creating a cache. Then, the multicast control process performed when a viewing request is submitted is terminated.

When the CPU 48 receives a notification that the creation of the cache is finished from the streaming server apparatus 2 (refer to Step S201 described below), the CPU 48 performs a process of delivering the cached content data to the viewer who is in the wait state and who is registered in the reserved viewer list T3.

If the CPU 48 determines in Step S108 that a cache of the content data for which the viewing request has been submitted is not creating in the preliminary streaming server apparatus 2 (the determination in Step S108 is negative), then in Step S109, the CPU 48 calculates the time t1 necessary to create a cache. For example, the CPU 48 substitutes a variety of data in the following expression to calculate the necessary time t1:

File size of content data/Time necessary to create cache of file size per unit−(Current time−Time when cache creation is started)

In Step S110, the CPU 48 calculates the remaining viewing time t2 of the first viewer who will finish the viewing, among the viewers who are in the viewing state. For example, the CPU 48 extracts the ID of the content for which the viewing request has been submitted from the delivery management information table T2 and selects the earliest viewing start time from the viewing start times corresponding to the extracted content ID. The CPU 48 substitutes a variety of data in the following expression to calculate the remaining viewing time t2:

Playback time of content−(Current time−Selected viewing start time)+(Allowable accumulated pause time−Current accumulated pause time)

If the CPU 48 determines that the current accumulated pause time exceeds the allowable accumulated pause time, the CPU 48 may issue an instruction to prohibit the pause of the delivery of the content data to the streaming server apparatus 2 to calculate the remaining viewing time t2. If the CPU 48 determines that the current count of pauses exceeds the allowable count of pause, the CPU 48 may issue the instruction to prohibit the pause of the delivery of the content data to the streaming server apparatus 2 to calculate the remaining viewing time t2. As a result, the degree can be suppressed in which the viewer who is viewing the content data stops the viewing to end the session established by the communication terminal apparatus of the viewer as soon as possible. Consequently, it is possible to reduce, if not prevent, the wait time of the viewer who is in the wait time from being unnecessarily prolonged.

In Step S111, the CPU 48 determines whether the calculated necessary time t1 is shorter than the remaining viewing time t2. If the CPU 48 determines that the necessary time t1 exceeds the remaining viewing time t2 (the determination in Step S111 is negative), the CPU 48 determines that the creation of a cache is inapplicable and, then in Step S113, the CPU 48 registers the ID of the viewer who has submitted the viewing request in the reserved viewer list T3 in association with the ID of the content for which the viewing request has been submitted and the number of the streaming server apparatus 2. Then, the multicast control process performed when a viewing request is submitted is terminated.

The CPU 48 returns to Step S101 after a reference time to repeat the multicast control process.

If the CPU 48 determines in Step S111 that the necessary time t1 is shorter than the remaining viewing time t2 (the determination in Step S111 is affirmative), then in Step S112, the CPU 48 determines that the creation of a cache is applicable and transmits an instruction to create a cache to the streaming server apparatus 2 where the original content is held.

The CPU 28 in the streaming server apparatus 2 receives the instruction to create a cache from the delivery control server apparatus 4 and reproduces the content data. The CPU 28 transmits the copy of the content data to the preliminary streaming server apparatus 2.

The CPU 28 in the preliminary streaming server apparatus 2 receives the copy of the content data and stores the received copy of the content data in a free space in the content database 3 as a cache.

When the CPU 48 in the delivery control server apparatus 4 receives the notification that the creation of the cache is finished from the streaming server apparatus 2 (refer to Step S201 described below), the CPU 48 performs the process of delivering the cached content data to the viewer who is in the wait state and who is registered in the reserved viewer list T3.

In Step S113, the CPU 48 in the delivery control server apparatus 4 registers the ID of the viewer who has submitted the viewing request in the reserved viewer list T3 in association with the ID of the content for which the viewing request has been submitted and the number of the preliminary streaming server apparatus 2 that has created a cache. Then, the multicast control process performed when a viewing request is submitted is terminated.

When the CPU 48 in the delivery control server apparatus 4 receives the notification that the creation of the cache is finished from the streaming server apparatus 2 (refer to Step S201 described below), the CPU 48 performs the process of delivering the cached content data to the viewer who is in the wait state and who is registered in the reserved viewer list T3.

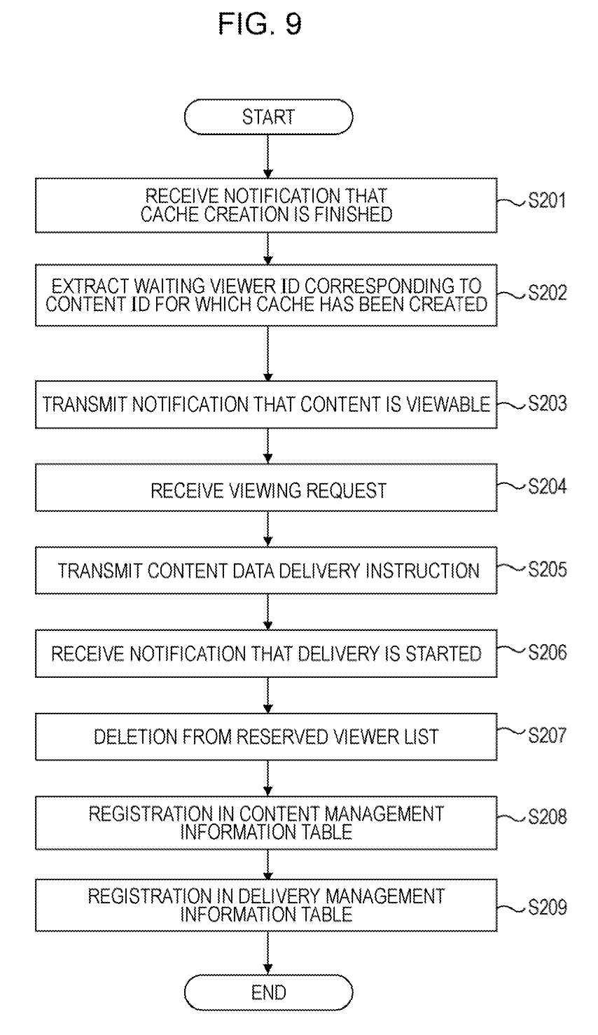

An example multicast control process performed by the delivery control server apparatus 4 when the creation of a cache is finished will now be described. FIG. 9 is a flowchart, according to an example embodiment of the invention, showing an example of the multicast control process performed when the creation of a cache is finished. When the creation of a cache is finished, the CPU 28 in the streaming server apparatus 2 transmits the notification that the creation of the cache is finished to the delivery control server apparatus 4.

Referring to FIG. 9, in Step S201, the CPU 48 in the delivery control server apparatus 4 receives the notification that the creation of the cache is finished from the streaming server apparatus 2. In Step S202, the CPU 48 extracts the ID of the viewer who corresponds to the ID of the content for which the cache has been created and who is in the wait state from the reserved viewer list T3. In Step S203, the CPU 48 transmits a notification that the content is viewable to the communication terminal apparatus 1 indicated by the extracted viewer ID.

The communication terminal apparatus 1 receives the notification from the delivery control server apparatus 4 and outputs the received notification for the user. When the communication terminal apparatus 1 receives a viewing request for the content data, input by the user in response to the output notification, the communication terminal apparatus 1 transmits the received viewing request to the delivery control server apparatus 4.

In Step S204, the CPU 48 in the delivery control server apparatus 4 receives the viewing request from the communication terminal apparatus 1. In Step S205, the CPU 48 transmits an instruction to deliver the content data to the preliminary streaming server apparatus 2 that has created the cache.

The CPU 28 in the preliminary streaming server apparatus 2 receives the instruction to deliver the content data from the delivery control server apparatus 4 and delivers the content data to the communication terminal apparatus 1 indicated by the ID of the viewer who has submitted the viewing request. The CPU 28 transmits a notification that the delivery of the content data is started to the delivery control server apparatus 4.

In Step S206, the CPU 48 in the delivery control server apparatus 4 receives the notification that the delivery of the content data is started from the preliminary streaming server apparatus 2. In Step S207, the CPU 48 deletes the ID of the viewer who has submitted the viewing request from the reserved viewer list T3 to decrease the number of the corresponding reservation viewers. In Step S208, the CPU 48 registers the number of the preliminary streaming server apparatus 2 that has started the delivery of the content data in the content management information table T1 in association with the ID of the delivered content. In Step S209, the CPU 48 registers the ID of the delivered content, the number of the preliminary streaming server apparatus 2 that has started the delivery of the content data, the viewer ID, the viewing start time, the accumulated pause time, the count of pauses, and the viewing state in the delivery management information table T2. Then, the multicast control process performed when the creation of a cache is finished is terminated.

When the CPU 48 receives a notification that the viewing is finished from the communication terminal apparatus 1, the CPU 48 performs a process described below.

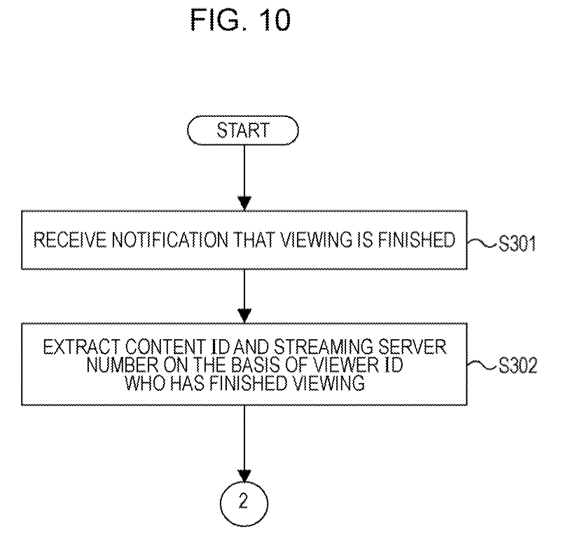

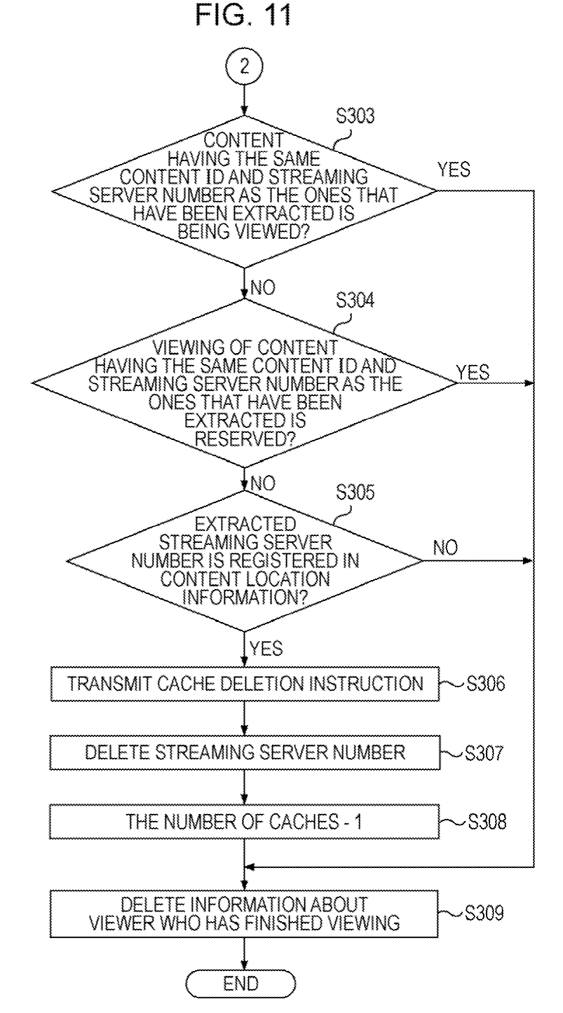

An example multicast control process performed by the delivery control server apparatus 4 when the viewing is finished will now be described. FIGS. 10 and 11 are flowcharts, according to respective example embodiments of the invention, showing an example of the multicast control process when the viewing is finished. When the playback of delivered content data is finished, the communication terminal apparatus 1 transmits the notification that the viewing is finished to the streaming server apparatus 2 delivering the content data. The streaming server apparatus 2 receives the notification from the communication terminal apparatus 1. The streaming server apparatus 2 stops the delivery of the content data and transmits the notification that the viewing is finished to the delivery control server apparatus 4.

Referring to FIG. 10, in Step S301, the CPU 48 in the delivery control server apparatus 4 receives the notification that the viewing is finished from the streaming server apparatus 2. In Step S302, the CPU 48 extracts the ID of the content for which the delivery is stopped and the number of the streaming server apparatus 2 that has stopped the delivery from the delivery management information table T2 on the basis of the ID of the viewer who has finished the viewing. Referring to FIG. 11, in Step S303, the CPU 48 searches the delivery management information table T2 to determine whether content having the same content ID and streaming server number as the ones that have been extracted is being viewed. If the CPU 48 determines that content having the same content ID and streaming server number as the ones that have been extracted is being viewed (the determination in Step S303 is affirmative), the CPU 48 determines that the cache should not be deleted and, then in Step S309, the CPU 48 deletes only information about the viewer who has finished the viewing from the delivery management information table T2. Then, the multicast control process performed when the viewing is finished is terminated.

If the CPU 48 determines in Step S303 that no content having the same content ID and streaming server number as the ones that have been extracted is being viewed (the determination in Step S303 is negative), the CPU 48 searches the reserved viewer list T3. In Step S304, the CPU 48 determines whether viewing of content having the same content ID and streaming server number as the ones that have been extracted is reserved on the basis of the search in the reserved viewer list T3. If the CPU 48 determines that viewing of content having the same content ID and streaming server number as the ones that have been extracted is reserved (the determination in Step S304 is affirmative), the CPU 48 determines that the cache should not be deleted and, then in Step S309, the CPU 48 deletes only information about the viewer who has finished the viewing from the delivery management information table T2. Then, the multicast control process performed when the viewing is finished is terminated.

If the CPU 48 determines that viewing of content having the same content ID and streaming server number as the ones that have been extracted is not reserved (the determination in Step S304 is negative), the CPU 48 searches the content management information table T1. In Step S305, the CPU 48 determines whether the extracted streaming server number is registered in the content location information on the basis of the search in the content management information table T1. If the CPU 48 determines that the extracted streaming server number is not registered in the content location information (the determination in Step S305 is negative), then in Step S309, the CPU 48 deletes only information about the viewer who has finished the viewing from the delivery management information table T2. Then, the multicast control process performed when the viewing is finished is terminated.

If the CPU 48 determines that the extracted streaming server number is registered in the content location information (the determination in Step S305 is affirmative), then in Step S306, the CPU 48 transmits an instruction to delete the cache to the streaming server apparatus 2 indicated by the extracted streaming server number. The CPU 28 in the streaming server apparatus 2 receives the instruction to delete the cache from the delivery control server apparatus 4 and deletes the cache in the content database 3 to which the streaming server apparatus 2 is connected. In Step S307, the CPU 48 deletes the extracted streaming server number from the content management information table T1. In Step S308, the CPU 48 subtracts one from the number of caches corresponding to the deleted streaming server number. In Step S309, the CPU 48 deletes information about the viewer who has finished the viewing from the delivery management information table T2. Then, the multicast control process performed when the viewing is finished is terminated.

If the number of deliveries in the delivery management information table T2 is subsequently decreased and the current number of deliveries becomes smaller than the maximum number of deliveries, the streaming server apparatus 2 where the original content is held delivers the content data.

Although the caches are created in the free space in the content database 3 for convenience in the example embodiments of the invention, additional data may be overwritten on data areas where data is recorded to create caches.

Although the embodiments of the present inventions have been described in detail, it should be understood that the various changes, substitutions, and alterations could be made hereto without departing from the spirit and scope of the invention.

What is claimed is:

1. A multicast control apparatus comprising:
a receiving unit to receive viewing requests for content data;
a delivery instructing unit to transmit, responsive to a first one of the received viewing requests, a delivery instruction for delivering to a first external apparatus the content data;
a delivery determining unit to determine, responsive to the first received viewing request, whether a corresponding number of deliveries of the content data exceeds a delivery limit;
a first calculating unit to calculate a time necessary to create a cache of a copy of the content data;
a second calculating unit to calculate a remaining time before viewing of the content data delivered from the first external apparatus is finished;
a time determining unit to determine whether the necessary time is shorter than the remaining time; and
a control unit to set a second and subsequent ones of the received viewing requests to a wait state if the delivery limit is exceeded by the first received viewing request, and to transmit a creation instruction for creating the cache to a second external apparatus if the time determining unit determines that the necessary time is shorter than the remaining time.

2. The multicast control apparatus according to claim 1, wherein:
the control unit is further operable to transmit a prohibition instruction for prohibiting pause of the delivery of content data to the first external apparatus if the delivery limit is exceeded by the first received viewing request; and
the second calculating unit is further operable to calculate the remaining time before the viewing of the content data is finished in a state where the pause of the delivery of the content data is prohibited by the prohibition instruction.

3. The multicast control apparatus according to claim 2,
wherein the control unit is further operable to transmit the prohibition instruction to the first external apparatus if an accumulated pause time exceeds a reference time.

4. The multicast control apparatus according to claim 2,
wherein the control unit is further operable to transmit the prohibition instruction to the first external apparatus if a count of pauses exceeds a reference count.

5. A multicast control system comprising:
a plurality of delivery apparatuses to multicast content data; and
a delivery control apparatus operatively coupled with the delivery apparatuses and including the following,
a receiving unit to receive viewing requests for content data;
a delivery instructing unit to transmit, responsive to a first one of the received viewing requests, a delivery instruction for delivering the content data to a first delivery apparatus;
a delivery determining unit to determine, responsive to the first received viewing request, whether a corresponding number of deliveries of the content data exceeds a delivery limit;
a first calculating unit to calculate a time necessary to create a cache of a copy of the content data;
a second calculating unit to calculate a remaining time before viewing of the content data delivered from the first delivery apparatus is finished;
a time determining unit to determine whether the necessary time is shorter than the remaining time; and
a control unit to set a second and subsequent ones of the received viewing requests to a wait state if the delivery limit is exceeded by the first received viewing request, and to cause transmission of a creation instruction for causing creation of a cache of the content data in a second external apparatus if the time determining unit determines that the necessary time is shorter than the remaining time.

6. The multicast control system according to claim 5, wherein:
the first delivery apparatus includes the following,
a receiving unit to receive the creation instruction; and
a transmitting unit to make a copy of the content data in response to the received creation instruction and to transmit the copy to the second delivery apparatus having the free storage space; and
the second delivery apparatus includes the following,
a receiving unit to receive the copy of the content data from the first delivery apparatus;
a cache unit to make a cache of the received copy of the content data in the free storage space; and
a multicast unit to multicast the cached content data in response to the delivery instruction transmitted from the delivery control apparatus; and
the control unit is further operable to cause the creation instructing unit to transmit the creation instruction if the time determining unit determines that the necessary time is shorter than the remaining time.

7. The multicast control system according to claim 6, wherein:
the delivery control apparatus further includes a prohibition instructing unit to transmit a prohibition instruction prohibiting pause of the delivery of content data to the first delivery unit when the control unit sets the received viewing request to the wait state,
the first delivery apparatus further includes the following,
a receiving unit to receive the prohibition instruction from the prohibition instructing unit; and
a prohibiting unit to prohibit the pause of the delivery of the content data in response to the received prohibition instruction; and
the second calculating unit is further operable to calculate the remaining time before the viewing of the content data is finished in a state where the pause of the delivery of the content data is prohibited by the prohibition instructing unit.

8. The multicast control system according to claim 7,
wherein the prohibition instructing unit is further operable to transmit the prohibition instruction to the first delivery apparatus if an accumulated pause time exceeds a reference time.

9. The multicast control system according to claim 7,
wherein the prohibition instructing unit is further operable to transmit the prohibition instruction to the first delivery apparatus if a count of pauses exceeds a reference count.

10. In a system including a delivery control apparatus and a plurality of delivery apparatuses operable to multicast content data in response to an instruction from the delivery control apparatus, a multicast method comprising:
receiving viewing requests for content data;
transmitting, to a first delivery apparatus, a creation instruction for creating a cache of a copy of the content data for which a first one of the received viewing requests has been submitted in a second delivery apparatus having a free storage area;
calculating a time necessary to create the cache;
calculating a remaining time before the viewing of the content data delivered from the first delivery apparatus is finished;
determining whether the necessary time is shorter than the remaining time; and
transmitting the creation instruction to create the cache of a copy of the content data in the second delivery apparatus and setting the received viewing request to the wait state in the reception order if the delivery control apparatus determines that the number of deliveries of the content data exceeds a delivery limit in response to the first received viewing request and that the necessary time is shorter than the remaining time.

11. The multicast control method according to claim 10, further comprising:
receiving the creation instruction; and
making a copy of the content data for which the viewing request has been submitted in response to the received creation instruction; and
the copy of the content data to the second delivery apparatus having the free storage space; receiving the copy of the content data from the first delivery apparatus;
making a cache of the received copy of the content data in the free storage space of the second delivery apparatus; and
multicasting the cached content data in response to a delivery instruction transmitted from the first delivery apparatus.
